(19) United States
(12) Patent Application Publication
(10) Pub. No.: US 2021/0192522 A1
(43) Pub. Date: Jun. 24, 2021

(54) INTELLIGENT FRAUD RULES

(71) Applicant: Visa International Service Association, San Francisco, CA (US)

(72) Inventors: Chelsea JAMESON, Denver, CO (US); Richard FISHER, Monument, CO (US); Curtis YEE, Redwood City, CA (US); Shane MALLOY, Castle Rock, CO (US)

(73) Assignee: Visa International Service Association, San Francisco, CA (US)

(21) Appl. No.: 16/720,866

(22) Filed: Dec. 19, 2019

(51) Int. Cl. G06Q 20/40; G06Q 10/10; G06Q 40/02; G06Q 40/00; G06F 16/23

(52) U.S. Cl. CPC G06Q 20/4016; G06Q 20/405; G06F 16/2379; G06Q 40/02; G06Q 40/12; G06Q 10/107

(57) ABSTRACT

Embodiments include apparatuses, methods, and systems for dynamically adjusting intelligent fraud rules based on payment transactions within a payment processing system. The embodiments receive a request to evaluate a transaction based on a false positive ratio (FPR) associated with a user's FPR threshold; and retrieve a first list of fraudulent transaction rules having fraud rules and FPRs; and remove fraudulent transaction rules from the first list of fraudulent transaction rules to create first fraudulent transaction rules aligned with the first FPR. The embodiments determine whether a set of parameters associated with the first fraudulent transaction rules are met based on the first FPR; transmit a decline response based on determination that the first fraudulent transaction rules are met; and generate a second list of fraudulent transaction rules dynamically adjusted based on the first list of fraudulent transaction rules and feedback data associated with the first fraudulent transaction rules.

### BACKGROUND

Millions of transactions occur daily through the use of payment cards, such as credit cards, debit cards, prepaid cards, electronic wallet applications, etc. Corresponding records of the transactions are recorded in databases for settlement and financial record-keeping. For example, a payment card corresponding to an account can be used to pay for a transaction when an account holder makes purchases from a merchant. The merchant thus forwards the financial transaction information to an acquiring bank (herein referred to as the “acquirer”).

A payment processor can receive the financial transaction information and then forwards it to the payment card issuing bank (the “issuer”) for approval. The issuer decides on whether or not to approve the cardholder's purchase. Existing models require that issuers have a great deal of technical infrastructure in order to support these payment cards. Additionally, maintaining the technical infrastructure is both expensive and difficult, as issuers must monitor and react to the performance of various, never-ending types of fraudulent payment card transactions. Issuers suffer a great deal of losses due to these fraud schemes.

In particular, one of the main problems of issuers is monitoring the ever-growing fraud schemes and their overall fraud rules performance. Various fraud rules are used to manage the risk of authorizing and/or declining fraudulent transactions. Moreover, developing fraud reduction strategies and performance models are generally done manually and rely heavily on human analysis. This process thus requires actual humans pulling reports, making calls, sending emails, etc., and then analyzing the pulled data to determine what fraud rules apply to which issuers. This leads to additional problems, however, as financial institutions often lack the expertise to effectively write fraud prevention models (or processes) in terms of business/financial fraudulent transaction rules that can quickly capture (or adapt) to the ever-changing fraudulent schemes. Accordingly, there is a need in the art for an automated and optimized process for monitoring/evaluating the performance of fraudulent transaction rules and adjusting the risk strategies for issuers based on such rules.

### BRIEF DESCRIPTION OF SEVERAL VIEWS OF THE DRAWINGS

FIG. 1 is an illustration of a block diagram of an electronic payment processing system configured to automatically update false positive ratio (FPR) performance of fraudulent transaction rules, according to some embodiments.

FIG. 2 is an illustration of a block diagram of a payment processor and an issuer configured to automatically update FPR performance of fraudulent transaction rules, according to some embodiments.

FIG. 3 is an illustration of a detailed block diagram of an electronic payment processing system configured to automatically evaluate and adjust FPR performance of fraudulent transaction rules, according to some embodiments.

FIG. 4 is an illustration of a block diagram of an electronic payment processing system configured to automatically evaluate and adjust FPR performance of fraudulent transaction rules, according to some embodiments.

FIG. 5 illustrates a flow diagram of a process for retrieving and adjusting FPR rule performance data points, according to one embodiment.

FIG. 6 illustrates a flow diagram of a process for assigning a FPR to an associated fraud rule in a list of fraudulent transaction rules, according to one embodiment.

FIG. 7 illustrates a flow diagram of a process for automatically updating a list of fraudulent transaction rules in a database platform in real-time with a plurality of fraud rules and a plurality of FPRs, according to one embodiment.

FIG. 8 illustrates a flow diagram of a process for comparing a FPR threshold of a client to a list of fraud rules and a plurality of FPRs, according to one embodiment.

FIG. 9 is a diagram illustrating processing of comparing FPR thresholds of clients to an updated list of fraudulent transaction rules, according to one embodiment.

FIGS. 10-11 are diagrams illustrating examples of payment transactions based on FPR performance of fraudulent transaction rules, according to some embodiments.

FIG. 12 illustrates an example device suitable for use to practice various aspects of the present disclosure, according to some embodiments.

### DETAILED DESCRIPTION

The embodiments described herein relate to financial services. The embodiments described below include a financial fraud prevention apparatus, system, method and computer-readable storage medium configured to automate and optimize false positive ratio (FPR) performance of fraud transaction rules using historical transaction data in an electronic payment processing system and to allow for more accurate and automated rule analysis, which respectively allows issuers (or clients) to target fraud more strategically and be closer to the issuer's/client's desired FPR.

The following description is presented to enable one of ordinary skill in the art to make and use the invention and is provided in the context of a patent application and its requirements. Various modifications to the exemplary embodiments and the generic principles and features described herein will be readily apparent. The embodiments described herein implement intelligent fraud rules as a mechanism for analyzing rule FPR performance over a designated trailing timeframe, and automatically populating and adjusting FPR tier lists based on FPR performance of the fraud rules. For example, a tier list would exist for 4:1, 3:1, 2:1, and 1:1 FPRs for every product, such as Domestic vs. International payment cards, card present vs. card not present, and so on. Instead of adjusting individual client rules, clients have the ability to choose how aggressive or conservative they want to be by selecting/designating a desired FPR rule performance (or a desired FPR threshold). In such example, rules meeting the desired FPR thresholds would be automatically adjusted to be included/excluded from a decline rule set based on the client's selected/desired FPR rule performance. Accordingly, the embodiments of the intelligent fraud rules described herein enable (i) increased frequent rule analysis to account for changes in models and the fraud environment, (ii) rule analysis across additional dimensions, (iii) the performance of the FPRs are more closely achieved, and (iv) reduced risk of error in rule maintenance processes.

The exemplary embodiments are mainly described in terms of particular methods and systems provided in particular implementations. However, the methods and systems will operate effectively in other implementations. Phrases such as “exemplary embodiment”, “one embodiment” and “another embodiment” may refer to the same or different embodiments. The embodiments will be described with respect to systems and/or devices having certain components. However, the systems and/or devices may include more or less components than those shown, and variations in the arrangement and type of the components may be made without departing from the scope of the invention. The exemplary embodiments will also be described in the context of particular methods having certain steps. However, the method and system operate effectively for other methods having different and/or additional steps and steps in different orders that are not inconsistent with the exemplary embodiments. Thus, the present invention is not intended to be limited to the embodiments shown, but is to be accorded the widest scope consistent with the principles and features described herein.

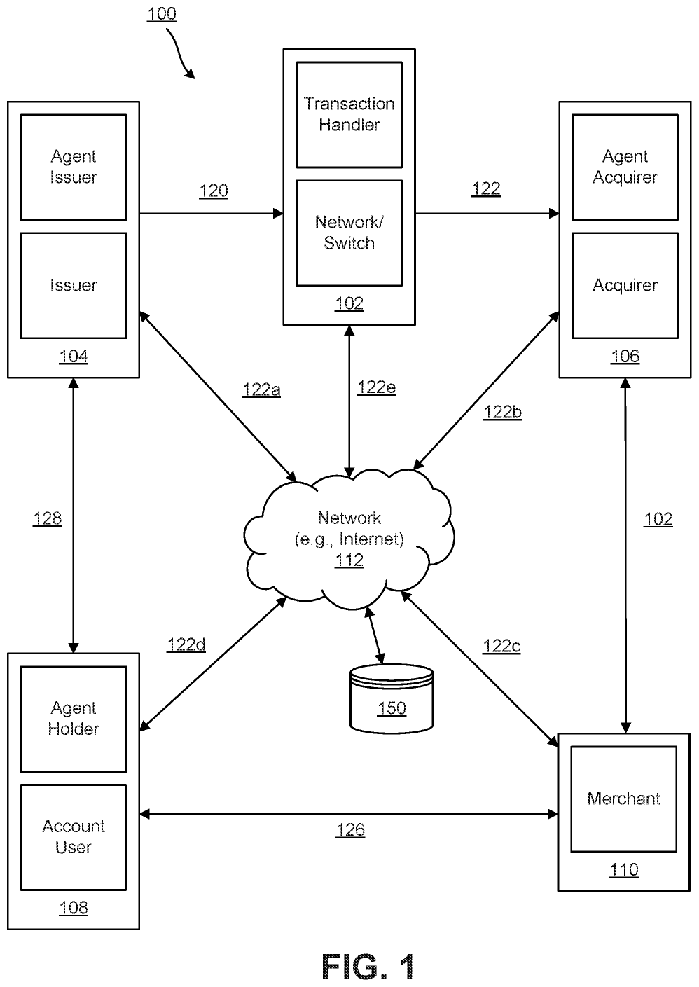

The embodiments described herein may implement the intelligent fraud rules used to automatically monitor and adjust the FPR performance of fraudulent transaction rules as shown below in reference to FIGS. 1-4. For example, the embodiments may include one or more computer-implemented methods (or processes) that implement such intelligent fraud rules. In some embodiments, a computer-implemented method may include receiving a request to evaluate a transaction based on a FPR, wherein the FPR is associated with a FPR threshold generated by a user (e.g., a client, an account holder, etc.); retrieving a first list of fraudulent transaction rules, where the first list of fraudulent transaction rules include fraud rules associated with FPRs; removing one or more fraudulent transaction rules from the first list of fraudulent transaction rules to create one or more first fraudulent transaction rules that are aligned with the first FPR of the FPR threshold of the user; determining whether a set of parameters associated with the one or more first fraudulent transaction rules are met based on the first FPR of the FPR threshold of the user; transmitting a decline response to the request to evaluate the transaction based on the determination that the one or more first fraudulent transaction rules are met; and generating a second list of fraudulent transaction rules based on the first list of fraudulent transaction rules, wherein the second list of fraudulent transaction rules is dynamically adjusted based on feedback data associated with the one or more first fraudulent transaction rules and the first list of fraudulent transaction rules.

Furthermore, these embodiments described herein may include that the FPR threshold of the user is associated with one or more rule performance data points; the plurality of rule performance data points may include a rule name, a plurality of rule inputs, a number of cases associated with rules confirmed fraud over a period of time, and a number of cases associated with rules confirmed not fraud over the period of time; the FPRs may be generated from one or more first cases associated with confirmed fraudulent transactions over the period of time, and one or more second cases associated with confirmed non-fraudulent transactions over the period of time; the feedback data may be comprised of a one or more verification responses that determine whether the transaction was a confirmed non-fraudulent transaction or a confirmed fraudulent transaction; and the verification responses may include an automated email response, an automated text message response, or an automated voice response.

Additionally, these embodiments described herein may transmit an approve response to the request to evaluate the transaction based on the determination that the one or more first fraudulent transaction rules are not met; generate a case to evaluate the decline response based on the feedback data; and receive a second request to evaluate a second transaction based on the first FPR and the second list of fraudulent transaction rules, where the second list of fraudulent transaction rules include a plurality of second fraud rules associated with a plurality of second FPRs, where at least one of the feedback data and the case dynamically adjusts the plurality of fraud rules and the plurality of FPRs of the first list of fraudulent transaction rules to generate the plurality of second fraud rules and the plurality of second FPRs of the second list of fraudulent transaction rules, where the FPR may include a 1:1 FPR, a 2:1 FPR, a 3:1 FPR, or a 4:1 FPR, where the 1:1 FPR indicates for one fraudulent transaction declined, one legitimate transaction suspected as fraudulent is erroneously declined, where the 2:1 FPR indicates for one fraudulent transaction declined, two legitimate transactions suspected as fraudulent are erroneously declined, and where the 3:1 FPR indicates for one fraudulent transaction declined, three legitimate transactions suspected as fraudulent are erroneously declined, and where the 4:1 FPR indicates for one fraudulent transaction declined, four legitimate transactions suspected as fraudulent are erroneously declined. As such, these embodiments, including the intelligent fraud rules, are described and illustrated below in further detail.

FIG. 1 is an illustration of a block diagram of an electronic payment processing system 100 (or a payment processing network) configured to automatically update FPR performance of fraudulent transaction rules, according to some embodiments. In the embodiments described herein, the electronic payment processing system 100 may be implemented to automate and optimize the performance of fraudulent transaction rules for issuers (or the like). Moreover, each of the process flow diagrams (or processes) described below may be presented in reference to the electronic payment processing system 100 of FIG. 1.

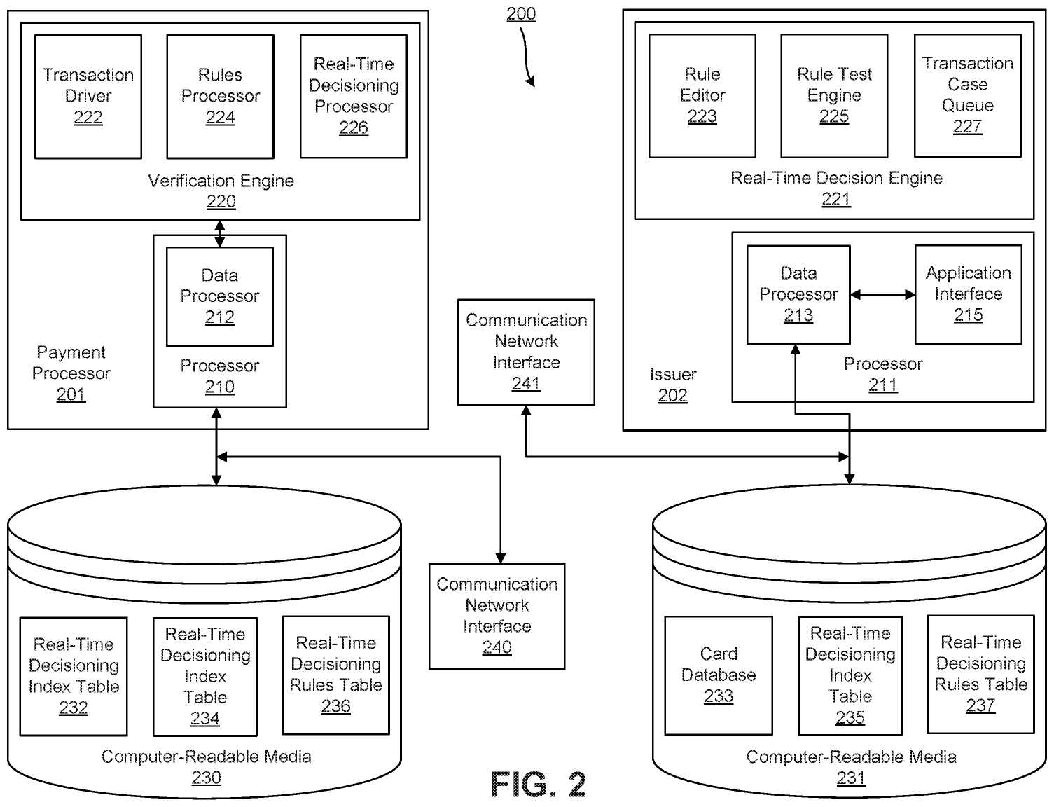

In the electronic payment processing system 100, a payment card is used by an account holder to conduct a transaction with a merchant on an account issued to the account holder by an issuer (or a client). The account holder uses a credit card or debit card, but it is understood that other payment card equivalents may be substituted. These equivalents may include, but are not limited to: a cellular telephone (e.g., a mobile phone), a key tag, an electronic wallet, a payment fob, or any other electronic payment device known in the art. As shown in FIG. 1, the electronic payment processing system 100 supports importing fraud prevention rules from an issuer 104 and implementing them in real-time at a transaction handler 102 (or a payment processor such as the payment processor 201 of FIG. 2). When the consumer, such as the account user 108, uses a payment card of an account holder 108 at a merchant 110 to pay for a product or service, the merchant 110 contacts an acquirer 106 (e.g., a commercial bank) to determine whether the consumer is credit worthy or the account has sufficient funds on the card to pay for the transaction. The acquirer 106 may then forward the details of the payment transaction to the transaction handler 102 for processing. It is understood that, for backward compatibility, the payment card, the merchant 110, and the acquirer 106, may be any payment card, merchant, and/or acquirer known in the art.

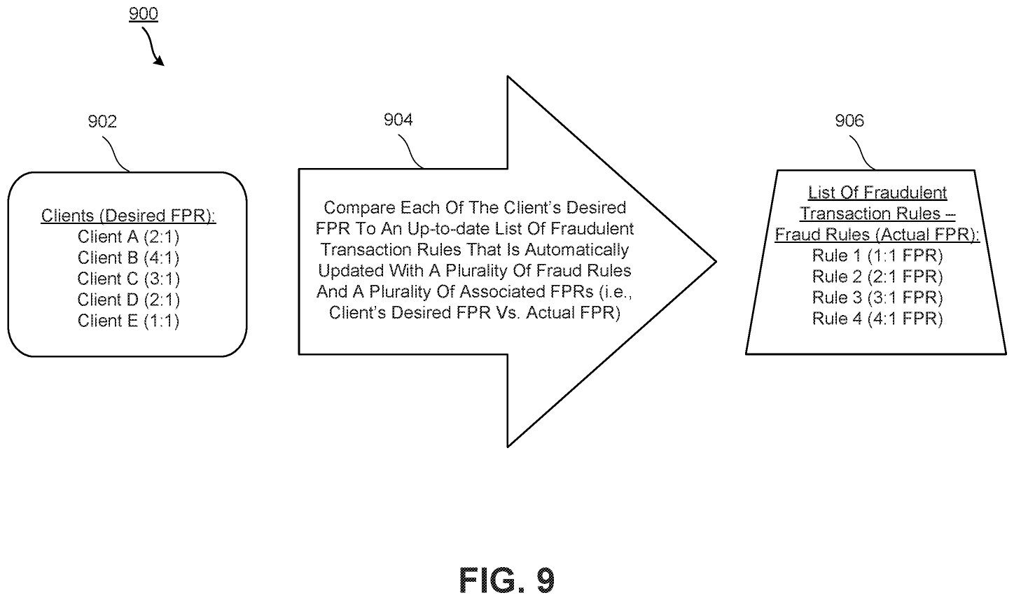

In one implementation, the transaction handler 102 may be any payment network configured to retrieve fraud rules from the issuer 104 in a risk database platform, where the confirmed case outcomes from those retrieved fraud rules generate a FPR, and to implement the retrieved fraud rules in real-time against a list of fraudulent transaction rules comprised a plurality of fraud rules associated with a plurality of FPRs (or a plurality of associated FPRs) (e.g., as shown at block 904 of FIG. 9). For example, the plurality of FPRs may be generated from (i) a plurality of first cases associated with a number of confirmed fraudulent transactions over a predetermined timeframe, and (ii) a plurality of second cases associated with a number of confirmed non-fraudulent transactions over the predetermined timeframe.

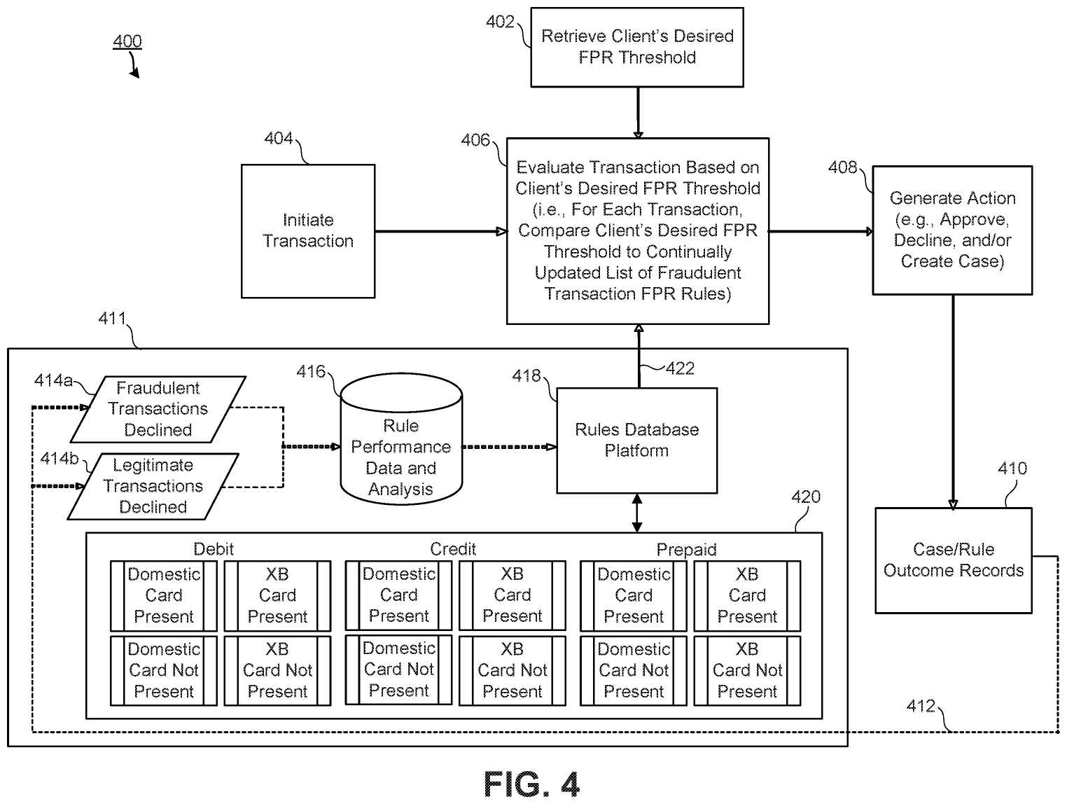

Thereafter, based on the retrieved/uploaded fraud rules from the issuer 104 (or the issuer 201 of FIG. 2), the transaction handler 102 determines whether (i) the transaction should be approved, (ii) the transaction should be declined, and/or (iii) the transaction should create a case (e.g., as shown with the case/rule outcome records 410 of FIG. 4), according to some embodiments. In some embodiments, the issuer 104 may be any payment card issuer that may establish (or select) a desired FPR threshold (or a desired/targeted FPR for fraudulent transaction rules). The issuer 104 may select the Desired risk threshold that is respectively associated with an overall FPR (e.g., 3:1). In these embodiments, the issuer 104 may be any payment card issuer configured to upload (or establish) the desired FPR threshold (and/or the fraudulent transaction rules and associated FPRs) to the transaction handler 102 for implementation in real-time as intelligent fraud rules, where such intelligent fraud rules (as described above) automatically enable and/or disable fraud rules based on the performance data of the issuer 104. Note that, in these embodiments, the issuer 104 may be a payment card issuer (or the like) that establishes (or selects) and monitors a FPR threshold of a client based on the client's desired (or selected/established) FPR threshold, where such client may be, but is not limited to, the account user 108, the merchant 110, and/or the acquirer 106 (e.g., a commercial bank).

For example, in some embodiments, the issuer 104 may establish a FPR threshold to be managed as part of a risk product of the payment processing system 100, where such product may allow the issuer 104 to currently understand its FPR rule performance over a specified time and ensure the issuer 104 is being accurately managed to the tier level they selected/desired. In an embodiment, the issuer 104 may include a workstation capable of creating, testing, and uploading fraud prevention rules to the transaction handler 102 if needed. Further details of the issuer 104 may be described below with the issuer 201 in FIG. 2. In yet another alternative implementation, the issuer 104 may implement (or select/set) the desired fraud rules, and need not to upload the fraud rules to the transaction handler 102.

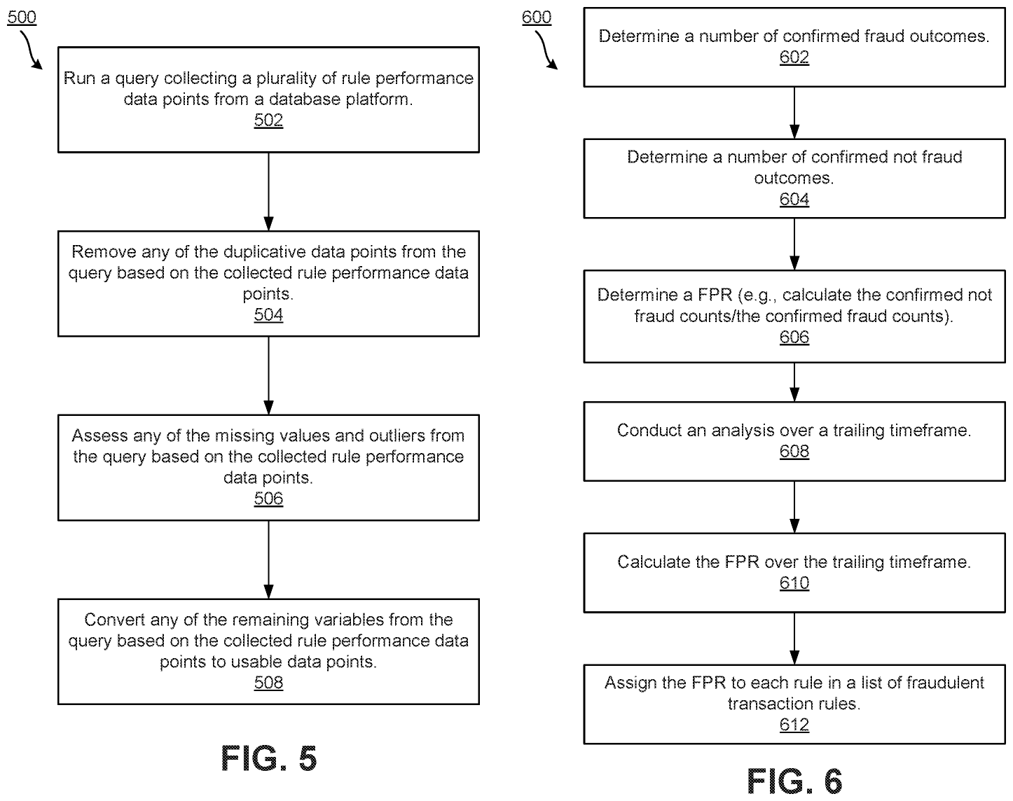

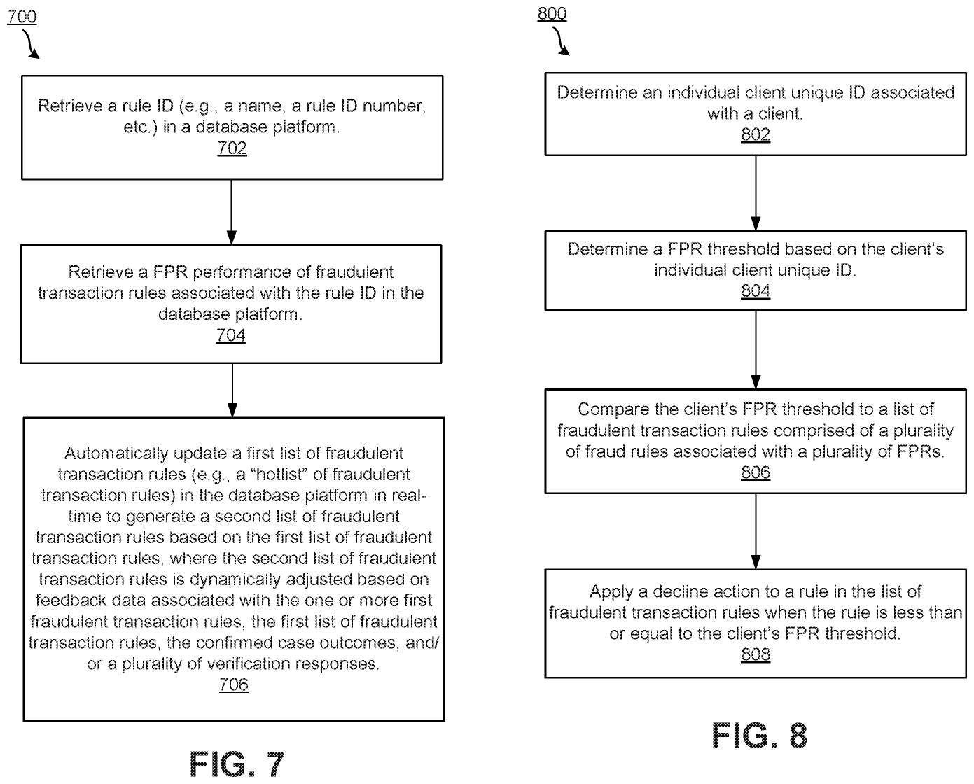

In some embodiments, the transaction handler 102 may be implemented for (i) data ingestion and structure of fraud rules (e.g., as shown in the process flow diagram 500 of FIG. 5), (ii) analysis of fraud rules (e.g., as shown in the process flow diagram 600 of FIG. 6), (iii) data transfer of fraud rules (e.g., as shown in the process flow diagram 700 of FIG. 7), and/or (iv) implementation/calculation and utilization of fraud rules (e.g., as shown in the process flow diagrams 800, 900, 1000, and 1100 of FIGS. 8-11). Implementations of the transaction handler 102 is now disclosed with reference to a payment processor 201 and an issuer 202 of the electronic payment processing system 200 of FIG. 2.

Note that the electronic payment processing system 100 may include fewer or additional components and processing steps based on the desired processing design.

FIG. 2 is a block diagram illustration of a payment transaction processing system 200 with a payment processor 201 and an issuer 202 configured to automatically update the FPR performance of fraudulent transaction rules, according to some embodiments. Payment processor 200 may run a multi-tasking operating system (OS) and include at least one processor or central processing unit (CPU) 210. Processor 210 may be any central processing unit, microprocessor, micro-controller, computational device or circuit known in the art.

It is well understood by those in the art, that the functional elements of FIG. 2 may be implemented in hardware, firmware, or as software instructions and data encoded on a computer-readable storage medium 230. As shown in FIG. 2, processor 210 is functionally comprised of a verification engine 220 and data processor 212. Verification engine 220 may further comprise: transaction driver 222, rules processor 224, and real-time decisioning processor 226. These structures may be implemented as hardware, firmware, or software encoded on a computer-readable medium, such as storage media 230.

Data processor 212 interfaces with storage medium 230 and network interface 240. The data processor 212 enables processor 210 to locate data on, read data from, and writes data to, these components. Network interface 240 may be any data port as is known in the art for interfacing, communicating or transferring data across a computer network. Examples of such networks include Transmission Control Protocol/Internet Protocol (TCP/IP), Ethernet, Fiber Distributed Data Interface (FDDI), token bus, or token ring networks. Network interface 240 allows payment transaction processing system 200 to communicate with issuer 202, and may allow communication with acquirer 106 of FIG. 1.

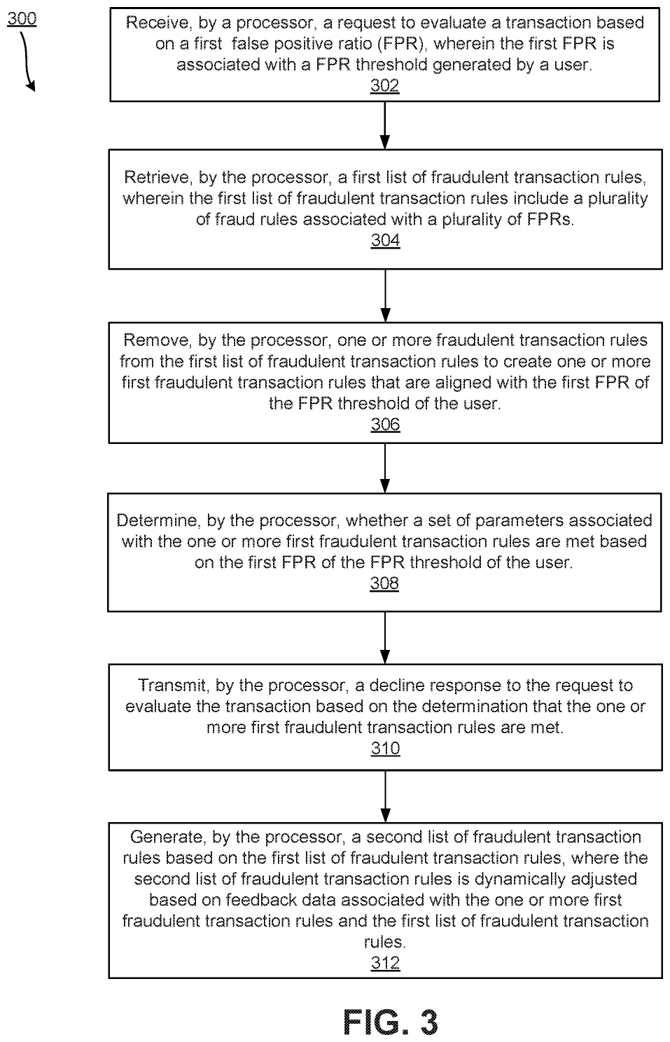

Computer-readable storage medium 230 may be a conventional read/write memory such as a magnetic disk drive, floppy disk drive, compact-disk read-only-memory (CD-ROM) drive, digital versatile disk (DVD) drive, high definition digital versatile disk (HD-DVD) drive, magneto-optical drive, optical drive, flash memory, memory stick, transistor-based memory or other computer-readable memory device as is known in the art for storing and retrieving data. Significantly, computer-readable storage medium 230 may be remotely located from processor 210, and be connected to processor 210 via a network such as a local area network (LAN), a wide area network (WAN), or the Internet. In addition, as shown in FIG. 2, storage media 230 may also contain a card database 232, a real time decisioning index table 234, and a master real time decisioning rules table 236. The function of these structures may best be understood with respect to the process flows (or schematics) of FIGS. 3-11, as described below.

As was previously mentioned, in some implementations, the issuer 202 may establish the intelligent fraud rules (e.g., the fraud rules, the issuer's desired FPR threshold, etc.) for one or more clients (or users) based on the client's desired/selected FPR threshold (or FPR target), where such intelligent fraud rules may be optimized by the processes described herein. As shown in FIG. 2, another implementation of an issuer 202 (shown in FIG. 1 as issuer 104) is illustrated. In the particular implementation, issuer 202 is configured to upload fraud prevention rules to a payment processor that implements the fraud rules in real-time. It is understood by those known in the art that the issuer's computing device 202 may be configured on any computing device, such as a workstation, personal computer, mini-computer, mainframe, or other computing device known in the art. For illustrative purposes only, we will assume that the computing device located at the issuer 202 is a computer workstation or the like.

Issuer 202 may run a multi-tasking operating system (OS) and include at least one processor or central processing unit 211. Processor 211 may be any central processing unit, microprocessor, micro-controller, computational device or circuit known in the art. It is further understood that processor 211 does not have to be the same model or make as processor 210.

Like the functional elements of the payment processor 201, it is well understood by those in the art, that the functional elements of the issuer 202 may be implemented in hardware, firmware, or as software instructions and data encoded on a computer-readable storage medium. As shown, processor 211 is functionally comprised of a real time decisioning engine 221, data processor 213, and application interface 215. Verification engine 221 may further comprise: rule editor 223, rule test engine 225, and transaction case queue 227. These structures may be implemented as hardware, firmware, or software encoded on a computer readable medium, such as storage media 231.

Data processor 213 interfaces with storage medium 231 and network interface 241. The data processor 213 enables processor 211 to locate data on, read data from, and write data to, these components.

Network interface 241 may be any data port as is known in the art for interfacing, communicating or transferring data across a computer network. Examples of such networks include Transmission Control Protocol/Internet Protocol (TCP/IP), Ethernet, Fiber Distributed Data Interface (FDDI), token bus, or token ring networks. Network interface 241 allows issuer 202 to communicate with payment processor 201.

Application interface 215 enables processor 211 to take some action with respect to a separate software application or entity. For example, application interface 215 may take the form of a graphical-user or windowing interface, as is commonly known in the art.

Computer-readable storage medium 231 may be a conventional read/write memory such as a magnetic disk drive, floppy disk drive, compact-disk read-only-memory (CD-ROM) drive, digital versatile disk (DVD) drive, high definition digital versatile disk (HD-DVD) drive, magneto-optical drive, optical drive, flash memory, memory stick, transistor-based memory or other computer-readable memory device as is known in the art for storing and retrieving data. Significantly, computer-readable storage medium 231 may be remotely located from processor 2110, and be connected to processor 211 via a network such as a local area network (LAN), a wide area network (WAN), or the Internet. In addition, as shown in FIG. 2, issuer storage media 231 may contain structures analogous with that of payment processor storage media 230. These structures include a card database 233, a real time decisioning index table 235, and a master real time decisioning rules database 237. The function of these structures may further be understood with respect to the process flows (or schematics) of FIGS. 3-11, as described below. Exemplary methods for automating and optimizing intelligent fraud rules for preventing/monitoring the FPR performance of fraud transaction rules as seen in FIGS. 3-11. It is understood by those known in the art that instructions for such method implementations may be stored on their respective computer-readable memory and executed by their respective processors.

Note that the system 200 may include fewer or additional components and processing steps based on the desired processing design.

FIG. 3 is an illustration of a process flow diagram 300 (or a flow diagram of a process) of an electronic payment processing system configured to automatically monitor, evaluate, and adjust the FPR performance of fraudulent transaction rules, according to some embodiments. The process flow diagram 300 of FIG. 3 may be implemented (or performed) with a payment processor (e.g., the payment processor 200 of FIG. 2), an issuer (e.g., the issuer 201 of FIG. 2), a transaction handler (e.g., the transaction handler 102 of FIG. 1), and/or one or more components of a electronic payment processing system (e.g., the electronic payment processing systems 100 and 200 of FIGS. 1-2). The process flow diagram 300 may be implemented by processing logic which may be implemented in software, firmware, hardware, or any combination thereof.

According to some embodiments, the process flow diagram 300 may be implemented to analyze a client's desired rule performance of FPRs over a designated trailing timeframe. In these embodiments, the process flow diagram 300 may provide automated and optimized fraudulent transaction rules and strategies for an issuer (e.g., the issuer 201 of FIG. 2) by, for example, determining (or calculating) the FPR performance of such fraudulent transaction rules in real-time (or on a predefined timeframe such as on a daily basis) and make web calls, batch files, and so on to the payment processing system to automatically (or daily) update the associated actions of the fraud rules (e.g., create case, approve action, decline action, etc.). Such process flow is further described below in accordance to one or more embodiments described herein.

At 302, a payment processor, such as the payment processor 200 of FIG. 2, receives a request to evaluate a transaction based on a first FPR and a second FPR, wherein the first FPR is associated with a FPR threshold generated by a user.

At 304, the payment processor retrieves a first list of fraudulent transaction rules associated with the second FPR, wherein the first list of fraudulent transaction rules include a plurality of fraud rules associated with a plurality of FPRs, and wherein the plurality of FPRs are generated from a plurality of first cases associated with confirmed fraudulent transactions over a predetermined timeframe, and a plurality of second cases associated with confirmed non-fraudulent transactions over the predetermined timeframe.

At 306, the payment processor removes one or more fraudulent transaction rules from the first list of fraudulent transaction rules to create one or more first fraudulent transaction rules that are aligned with the first FPR of the FPR threshold of the user. At 308, the payment processor determines whether a set of parameters associated with the one or more first fraudulent transaction rules are met based on the first FPR of the FPR threshold of the user, where the parameters may be based on one or more conditions such as, but not limited to, determining the payment card used for the transaction, whether the payment card was used domestically or international, whether the payment card was present or not present, whether the payment card was a debit card, a credit card, and/or a prepaid card, and so on. At 310, the payment processor transmits a decline response to the request to evaluate the transaction based on the determination that the one or more first fraudulent transaction rules are met. At 312, the payment processor generates a second list of fraudulent transaction rules to automatically update the second FPR, wherein the second list of fraudulent transaction rules is dynamically adjusted based on feedback data associated with the one or more first fraudulent transaction rules.

Note that the process flow diagram 300 may include fewer or additional components and processing steps based on the desired processing design.

FIG. 4 is an illustration of a block diagram of an intelligent fraud rules schematic 400 configured to automatically evaluate and adjust FPR performance of fraudulent transaction rules, according to some embodiments. The process flow of the schematic 400 of FIG. 4 may be implemented (or performed) with a payment processor (e.g., the payment processor 200 of FIG. 2), an issuer (e.g., the issuer 201 of FIG. 2), a transaction handler (e.g., the transaction handler 102 of FIG. 1), and/or one or more components of a electronic payment processing system (e.g., the electronic payment processing systems 100 and 200 of FIGS. 1-2). The process flow diagram of the schematic 400 may be implemented by processing logic which may be implemented in software, firmware, hardware, or any combination thereof. Such process flow is further described below in accordance to one or more embodiments described herein.

At 402, a payment processor, such as the payment processor 200 of FIG. 2, retrieves a client's desired FPR threshold (e.g., a FPR threshold of 3:1). At 404, the payment processor may receive a request to evaluate an initiated transaction. At 406, the payment processor evaluates the transaction based on the client's retrieved/desired FPR threshold at 402. For example, for each transaction, the payment processor compares the client's desired FPR threshold to a continually updated list of fraudulent transaction fraud rules (i.e., the intelligent fraud rules). Such intelligent fraud rules provides a mechanism (as shown in the schematic 400 of FIG. 4) for analyzing the performance of fraud rules over designated trailing timeframes and automatically populating/adjusting the FPR tier lists based on the performance of the fraud rules. For example, a tier list may include FPRs for 4:1, 3:1, 2:1, and 1:1 (as shown at block 420). Additionally, instead of adjusting individual client rules, clients have the ability to select how aggressive or conservative they want to be by rule FPR performance at 402. In these embodiments, as shown at 408, the rules meeting the desired FPR performance thresholds may/would be automatically adjusted to be included/excluded from a generated action of decline/approve/create case rule set based on the client's desired FPR threshold performance.

Accordingly, at 410, the payment processor allows for more accurate and automated rule analysis by tracking the case/rule outcome records, which in turn allows the clients to target fraud more strategically and be closer to the “actual” desired FPR threshold (as initially selected at 402). Thereafter, the payment processor utilizes a real-time decision engine at 411 (e.g., the real-time decision engines 221 of FIG. 2) that implements a continuous feedback loop to automatically update/adjust the list of fraudulent transaction rules at 412, where the payment processor conducts an analysis of the declined fraudulent transactions and the declined legitimated transactions at 414a-b, respectively. At 416, 418, and 420, the payment processor actively analyzes a FPR rule performance database with updated rules and associated FPRs, where the payment processor implements a rules database platform and a table of transaction data points (e.g., debit, credit, prepaid transactions). Lastly, at 422, the payment processor automatically (or in real-time) adjusts the rules database platform at 418 to be utilized at 406 for the subsequent/next initiated transaction (i.e., comparing the clients desired FPR threshold against the new/actual FPR as updated with the rules database platform at 418).

Note that the schematic 400 may include fewer or additional components and processing steps based on the desired processing design.

FIG. 5 illustrates a process flow diagram 500 for retrieving and adjusting FPR rule performance data points, according to one embodiment. The process flow diagram 500 of FIG. 5 may be implemented (or performed) with a payment processor (e.g., the payment processor 200 of FIG. 2), an issuer (e.g., the issuer 201 of FIG. 2), a transaction handler (e.g., the transaction handler 102 of FIG. 1), and/or one or more components of a electronic payment processing system (e.g., the electronic payment processing systems 100 and 200 of FIGS. 1-2). The process flow diagram 500 may be implemented by processing logic which may be implemented in software, firmware, hardware, or any combination thereof. Such process flow is further described below in accordance to one or more embodiments described herein.

At 502, a payment processor, such as the payment processor 200 of FIG. 2, runs a query collecting a plurality of rule performance data points from a database platform. For example, the rule performance data points may include, but are not limited to, a rule name, rule inputs, a number of cases associated with rule confirmed fraud over X period of time, a number of cases associated with rule confirmed not fraud over X period of time, and/or an issuer's FPR requirements. In these examples, the issuer's FPR requirements may include an issuer's selected/desired FPR threshold.

At 504, the payment processor removes any of the duplicative data points from the query based on the collected rule performance data points. At 506, the payment processor assesses any of the missing values and outliers from the query based on the collected rule performance data points. At 508, the payment processor Convert any of the remaining variables from the query based on the collected rule performance data points to usable data points.

Note that the process flow diagram 500 may include fewer or additional components and processing steps based on the desired processing design.

FIG. 6 illustrates a process flow diagram 600 for assigning an FPR to an associated rule in a list of fraudulent transaction rules, according to one embodiment. The process flow diagram 600 of FIG. 6 may be implemented (or performed) with a payment processor (e.g., the payment processor 200 of FIG. 2), an issuer (e.g., the issuer 201 of FIG. 2), a transaction handler (e.g., the transaction handler 102 of FIG. 1), and/or one or more components of a electronic payment processing system (e.g., the electronic payment processing systems 100 and 200 of FIGS. 1-2). The process flow diagram 600 may be implemented by processing logic which may be implemented in software, firmware, hardware, or any combination thereof. Such process flow is further described below in accordance to one or more embodiments described herein.

At 602, a payment processor, such as the payment processor 200 of FIG. 2, determines a number of confirmed fraud outcomes. At 604, the payment processor determines a number of confirmed not fraud outcomes. At 606, the payment processor determines a FPR (e.g., the processor may calculate the confirmed not fraud counts/the confirmed fraud counts). At 608, the payment processor conducts an analysis over a trailing timeframe. At 610, the payment processor calculates the FPR over the trailing timeframe. At 612, the payment processor assigns the FPR to each rule in a list of fraudulent transaction rules.

Note that the process flow diagram 600 may include fewer or additional components and processing steps based on the desired processing design.

FIG. 7 illustrates a process flow diagram 700 for automatically updating a list of fraudulent transaction rules in a database platform in real-time with a plurality of fraud rules and a plurality of FPRs, according to one embodiment. The process flow diagram 700 of FIG. 7 may be implemented (or performed) with a payment processor (e.g., the payment processor 200 of FIG. 2), an issuer (e.g., the issuer 201 of FIG. 2), a transaction handler (e.g., the transaction handler 102 of FIG. 1), and/or one or more components of a electronic payment processing system (e.g., the electronic payment processing systems 100 and 200 of FIGS. 1-2). The process flow diagram 700 may be implemented by processing logic which may be implemented in software, firmware, hardware, or any combination thereof. Such process flow is further described below in accordance to one or more embodiments described herein.

At 702, a payment processor, such as the payment processor 200 of FIG. 2, retrieves a rule ID (e.g., a name, a rule ID number, etc.) in a database platform. At 704, the payment processor retrieves a FPR performance of fraudulent transaction rules associated with the rule ID in the database platform. At 706, the payment processor automatically updates (or adjusts) a first list of fraudulent transaction rules (e.g., a “hotlist” of fraudulent transaction rules) in the database platform in real-time to generate a second list of fraudulent transaction rules based on the first list of fraudulent transaction rules. In one embodiment, the second list of fraudulent transaction rules may be dynamically adjusted based on feedback data associated with, but not limited to, (i) the one or more first fraudulent transaction rules, (ii) the first list of fraudulent transaction rules, (iii) the confirmed case outcomes (e.g., the data generated/recorded/collected by the Case/Rule Outcome Records 410 of FIG. 4), (iiii) a plurality of verification responses implemented to determine whether the transaction was a confirmed non-fraudulent transaction or a confirmed fraudulent transaction, where the plurality of verification responses may include, but are not limited to, an automated email response, an automated text message response, and/or an automated voice response.

Note that the process flow diagram 700 may include fewer or additional components and processing steps based on the desired processing design.

FIG. 8 illustrates a process flow diagram 800 for comparing a FPR threshold of a client to a list of fraudulent transaction rules comprised of a plurality of fraud rules and a plurality of FPRs, according to one embodiment. The process flow diagram 800 of FIG. 8 may be implemented (or performed) with a payment processor (e.g., the payment processor 200 of FIG. 2), an issuer (e.g., the issuer 201 of FIG. 2), a transaction handler (e.g., the transaction handler 102 of FIG. 1), and/or one or more components of a electronic payment processing system (e.g., the electronic payment processing systems 100 and 200 of FIGS. 1-2). The process flow diagram 800 may be implemented by processing logic which may be implemented in software, firmware, hardware, or any combination thereof. Such process flow is further described below in accordance to one or more embodiments described herein.

At 802, a payment processor, such as the payment processor 200 of FIG. 2, determines an individual client unique ID associated with a client. At 804, the payment processor determines a FPR threshold based on the client's individual client unique ID. At 806, the payment processor compares the client's FPR threshold to the plurality of fraud rules and associated FPRs of the list of fraudulent transaction rules. At 808, the payment processor applies a decline action to a rule (or a fraud rule) in the list of fraudulent transaction rules when the rule is less than or equal to the client's FPR threshold.

Note that the process flow diagram 800 may include fewer or additional components and processing steps based on the desired processing design.

FIG. 9 is a process flow diagram 900 illustrating processing of comparing FPR thresholds of clients to an updated list of fraudulent transaction rules, according to one embodiment. The process flow diagram 900 of FIG. 9 may be implemented (or performed) with a payment processor (e.g., the payment processor 200 of FIG. 2), an issuer (e.g., the issuer 201 of FIG. 2), a transaction handler (e.g., the transaction handler 102 of FIG. 1), and/or one or more components of a electronic payment processing system (e.g., the electronic payment processing systems 100 and 200 of FIGS. 1-2). The process flow diagram 900 may be implemented by processing logic which may be implemented in software, firmware, hardware, or any combination thereof. Such process flow is further described below in accordance to one or more embodiments described herein.

At 902, a payment processor, such as the payment processor 200 of FIG. 2, may retrieve and determine a desired FPR threshold of a client such as Client A (2:1), Client B (4:1), Client C (3:1), Client D (2:1), and Client E (1:1). At 904, the payment processor may compare the client's desired FPR (or the client's FPR threshold) (as shown at block 902) to an updated list of fraudulent transaction rules as shown at block 906, which is automatically updated with a plurality of fraud rules and a plurality of FPRs (i.e., a client's desired FPR as compared to an actual FPR). For example, at 906, the payment processor may utilize the updated list of fraudulent transaction rules (i.e., the actual fraud rules associated with the actual FPRs), which includes Rule 1 (1:1 FPR), Rule 2 (2:1 FPR), Rule 3 (3:1 FPR), and Rule 4 (4:1 FPR), to (i) compare the client's FPR threshold to a list of fraudulent transaction rules comprised of a plurality of fraud rules and a plurality of FPRs, and (ii) apply an action (e.g., a decline action, an approve action, a case create, etc.) to a rule in the list of fraudulent transaction rules when the rule's FPR is less than or equal to the client's desired FPR threshold.

Note that the process flow diagram 900 may include fewer or additional components and processing steps based on the desired processing design.

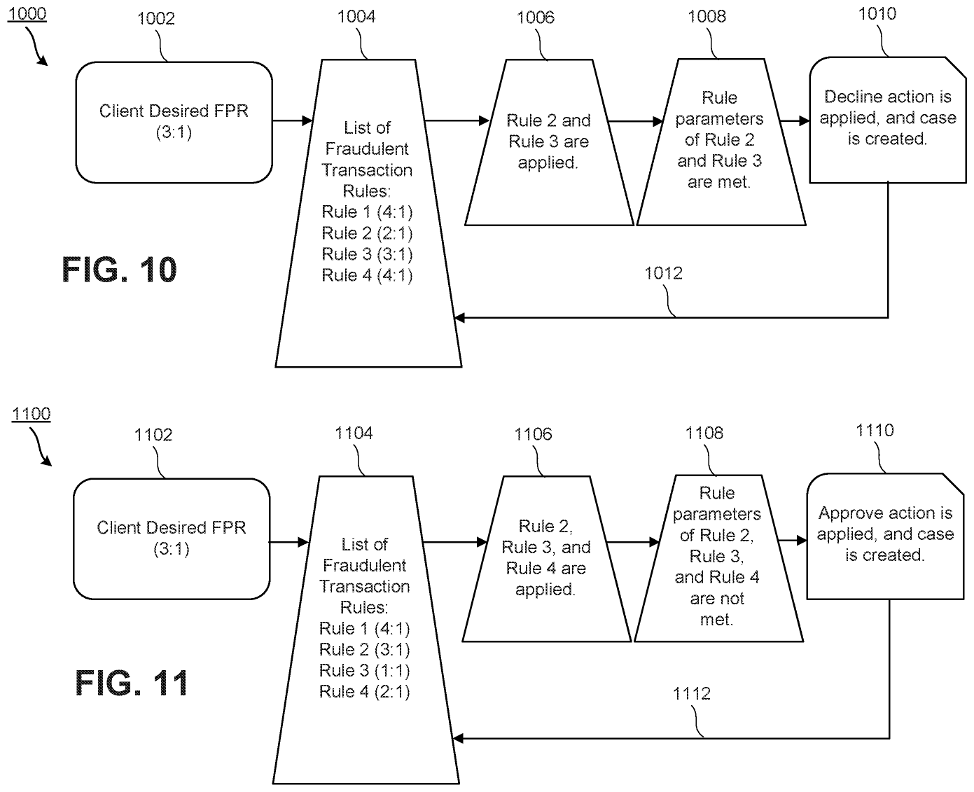

FIGS. 10-11 are process flow diagrams 1000 and 1100 illustrating examples of payment transactions with continued analysis and rule adjustment of a client's FPR performance of fraudulent transaction rules, according to some embodiments. The process flow diagrams 1000 and 1100 of FIGS. 10-11 may be implemented (or performed) with a payment processor (e.g., the payment processor 200 of FIG. 2), an issuer (e.g., the issuer 201 of FIG. 2), a transaction handler (e.g., the transaction handler 102 of FIG. 1), and/or one or more components of a electronic payment processing system (e.g., the electronic payment processing systems 100 and 200 of FIGS. 1-2). The process flow diagrams 1000 and 1100 may be implemented by processing logic which may be implemented in software, firmware, hardware, or any combination thereof. Such process flow is further described below in accordance to one or more embodiments described herein.

In particular, according to an embodiment, the process flow diagram 1000 illustrates a first example of a payment transaction based on a client's desired FPR (as shown at block 1002) and a list of fraudulent transaction rules (as shown at block 1004). In these embodiments, at 1006, a payment processor, such as the payment processor 200 of FIG. 2, may apply (or trigger) Rules 2 and 3 based on the payment transaction and the client's desired FPR being less than or equal to the FPRs associated with Rules 2 and 3. Thereafter, at block 1008, the payment processor determines that the rule parameters of Rule 2 and Rule 3 are met. Lastly, as shown at block 1010, the payment processor may generate a decline action (i.e., the payment transaction is declined) and a case is created, where the payment processor, at 1012, thus continually monitors the rule performance for the client, and continually adjusts the list of fraudulent transaction rules to be up-to-date in real-time (without requiring the client (or the issuer) of constantly monitoring their overall fraud rules performance and strategies).

Whereas, according to another embodiment, the process flow diagram 1100 illustrates a second example of a payment transaction based on a client's desired FPR (as shown at block 1102) and a list of fraudulent transaction rules (as shown at block 1104), where the payment transaction of the second example is the same as the payment transaction of the first example (i.e., the same merchant, and the transaction is for the same dollar amount) with the exception that the second example was conducted at a later timeframe (e.g., three months later). In these embodiments, at 1106, the payment processor may apply (or trigger) Rules 2, 3, and 4 based on the payment transaction and the client's desired FPR being less than or equal to the FPRs associated with Rules 2, 3, and 4. In some embodiments, the rules (e.g., Rules 2, 3, and 4) applied for the client are based on the performance of all the rules (i.e., the rules applied for the client(s) may not be typically based on the individual rule performance unless desired). For example, when the client provides the issuer with a FPR of 3:1 (as the client's desired FPR), the payment processor may utilize the aggregate performance of all the rules to get (or implement) the client's desired 3:1 FPR.

Thereafter, at block 1108, the payment processor determines that the rule parameters of Rule 2, Rule 3, and Rule 4 are not met, for example, based on the aggregate performance of all the rules and the client's desired FPR. Lastly, as shown at block 1110, the payment processor may generate an approve action (i.e., the payment transaction is approved) and a case is created, where the payment processor, at 1112, thus continually monitors (or analyzes/evaluates) the rule performance for the client, and continually adjusts the list of fraudulent transaction rules to be up-to-date in real-time (without requiring the client (or the issuer) of constantly monitoring their overall fraud rules performance and strategies).

Note that the process flow diagrams 1000 and 1100 of FIGS. 10-11 may include fewer or additional components and processing steps based on the desired processing design.

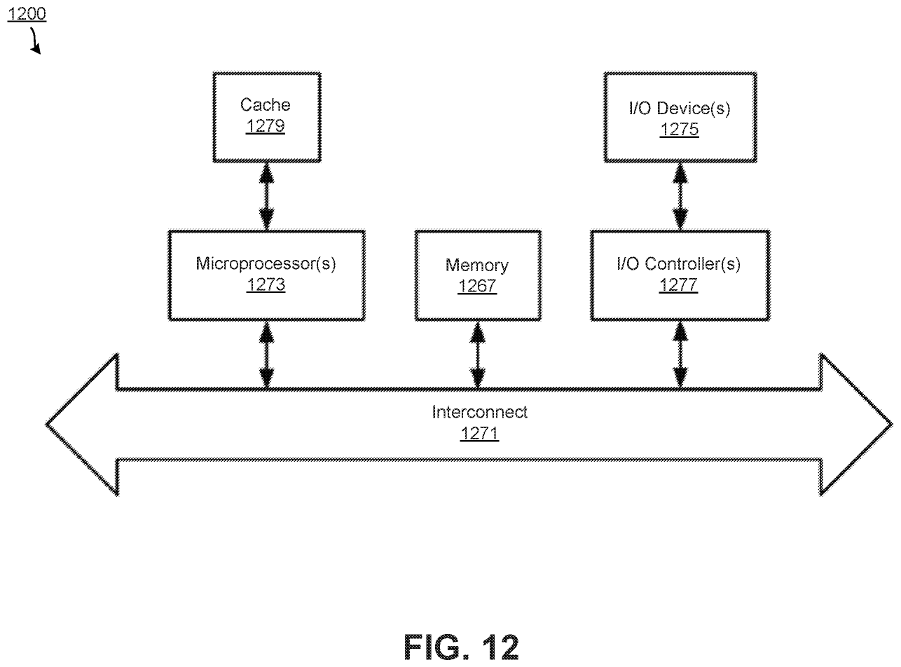

FIG. 12 illustrates an example device suitable for use to practice various aspects of the present disclosure, according to some embodiments. FIG. 12 illustrates an example device suitable for use to practice various aspects of the present disclosure, in accordance with various embodiments. While FIG. 12 illustrates various components of a computer system, it is not intended to represent any particular architecture or manner of interconnecting the components. One embodiment may use other systems that have fewer or more components than those shown in FIG. 12.

In FIG. 12, the data processing system 1200 includes an inter-connect 371, e.g., bus and system core logic, which interconnects a microprocessor(s) 1273, memory 1267, and input/output (I/O) device(s) 1275 via I/O controller(s) 1277. The microprocessor 1273 is coupled to cache memory 1279. I/O devices 1275 may include a display device and/or peripheral devices, such as mice, keyboards, modems, network interfaces, printers, scanners, video cameras and other devices known in the art. In one embodiment, when the data processing system is a server system, some of the I/O devices 1275, such as printers, scanners, mice, and/or keyboards, are optional.

In one embodiment, the interconnect 1271 includes one or more buses connected to one another through various bridges, controllers and/or adapters. In one embodiment, the I/O controllers 1277 include a USB (Universal Serial Bus) adapter for controlling USB peripherals, and/or an IEEE-1394 bus adapter for controlling IEEE-1394 peripherals.

In one embodiment, the memory 1267 includes one or more of: ROM (Read Only Memory), volatile RAM (Random Access Memory), and non-volatile memory, such as hard drive, flash memory, etc. Volatile RAM is typically implemented as dynamic RAM (DRAM) which requires power continually in order to refresh or maintain the data in the memory. Non-volatile memory is typically a magnetic hard drive, a magnetic optical drive, an optical drive (e.g., a DVD RAM), or other type of memory system which maintains data even after power is removed from the system. The non-volatile memory may also be a random access memory. The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In this description, some functions and operations are described as being performed by or caused by software code to simplify description. That is, the techniques may be carried out in a computer system or other data processing system such as the payment processing system 100 of FIG. 1 in response to its processor, such as a microprocessor, executing sequences of instructions contained in a memory, such as ROM, volatile RAM, non-volatile memory, cache or a remote storage device.

Alternatively, or in combination, the functions and operations as described here can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

Accordingly, the system 100 may implement the intelligent fraud rules that may run automatically and without user intervention. In such implementations, historical intelligent fraud rules (and associated lists, FPRs, etc.) are continually analyzed to create new sets of automated and optimized business rules that are automatically implemented either by the issuer 104 and/or by the payment processor such as the transaction handler 102. The historical transaction data can be limited to one issuer or can include both this issuer and its peers, where ‘peer’ can be defined in a variety of ways to create a variety of analyzes and resultant optimized business rules that specify how to treat future transactions relative to authorization and fraud prevention. The historical transaction data can also include multiple transaction handlers 102. As such, it would be advantageous for the transaction handler 102 who handles, and/or has access to, the past transaction data for other transaction handlers 102. Such a transaction handler 102, through its access to a larger collection of historical transaction data, would able to data mine' the past transaction data for other transaction handlers 102, and thereby have a better picture of fraud patterns and trends for its issuers.

By way of example of one implementation, an operations research analysis can be performed upon data of past transactions in a payment processing system such as is described below relative to FIG. 1. This analysis can determine, from data of past transactions, a low risk authorization score threshold for future transactions, and a high risk authorization score threshold for future transactions. A set of business rules can then be determined to maximize the number of future transactions to authorize which are equal to or less than the low risk authorization score threshold, and to minimize the number of high risk future transactions to authorize which are equal to or greater than the high risk authorization score threshold. These business rules, so optimized, are then implemented in a real time decisioning processor. Thereafter, for each of a plurality of future transactions, the implementation: (i) compares the transaction with the implemented set of intelligent fraud rules in the real time decisioning processor; (ii) determined from the comparison whether the transaction should be declined/approved/case created; and (iii) transmits a decline message when the transaction should be declined.

Referring back to FIG. 1, the methods and the process flow diagrams disclosed above/herein may be operated in the transaction processing system 100. The general environment of FIG. 1 includes that of a merchant 110, such as the merchant, who can conduct a transaction for goods and/or services with an account user (e.g., consumer) on an account issued to an account holder 108 by an issuer 104, where the processes of paying and being paid for the transaction are coordinated by at least one transaction handler 102 (e.g., the transaction handler) (collectively “users”). The transaction includes participation from different entities that are each a component of the transaction processing system 100.

The transaction processing system 100 may have at least one of a plurality of transaction handlers 102 that includes transaction handler 102 through transaction handler 102, where TH can be up to and greater than an eight digit integer. The transaction processing system 100 has a plurality of merchants 110 that includes merchant 110 through merchant 110, where M can be up to and greater than an eight digit integer. Merchant 110 may be a person or entity that sells goods and/or services. Merchant 110 may also be, for instance, a manufacturer, a distributor, a retailer, a load agent, a drugstore, a grocery store, a gas station, a hardware store, a supermarket, a boutique, a restaurant, or a doctor's office. In a business-to-business setting, the account holder 108 may be a second merchant 110 making a purchase from another merchant 110.

Transaction processing system 100 includes account user 108 through account user 108, where account user 108 can be as large as a ten digit integer or larger. Each account user 108 conducts a transaction with merchant 110 for goods and/or services using the account that has been issued by an issuer 104 to a corresponding account holder 108. Data from the transaction on the account is collected by the merchant 110 and forwarded to a corresponding acquirer 106. Acquirer 106 forwards the data to transaction handler 102 who facilitates payment for the transaction from the account issued by the issuer 104 to account holder 108.

Transaction processing system 100 has a plurality of acquirers 106. Each acquirer 106 may be assisted in processing one or more transactions by a corresponding agent acquirer 106, which may represented as an integer from 1 to Q, and another integer from 1 to AQ, and where Q and AQ can be as large as an eight digit integer or larger. Each acquirer 106 may be assisted in processing one or more transactions by a corresponding agent acquirer 106, which may represent an integer from 1 to Q, another integer from 1 to AQ, and where Q and AQ can be as large as an eight digit integer or larger.

The transaction handler 102 may process a plurality of transactions within the transaction processing system 100. The transaction handler 102 can include one or a plurality or networks and switches 102. Each network/switch 102 can be a mainframe computer in a geographic location different than each other network/switch 102, which may be represented as an integer from one to NS, and where NS can be as large as a four digit integer or larger.

Dedicated communication systems 120, 122 (e.g., private communication network(s)) facilitate communication between the transaction handler 102 and each issuer 104 and each acquirer 106. A Network 112, via e-mail, the World Wide Web, cellular telephony, and/or other optionally public and private communications systems, can facilitate communications 122a-e among and between each issuer 104, each acquirer 106, each merchant 110, each account holder 108, and the transaction handler 102. Alternatively and optionally, one or more dedicated communication systems 124, 126, and 128 can facilitate respective communications between each acquirer 106 and each merchant 110, each merchant and each account holder 108, and each account holder 108 and each issuer 104, respectively.

The Network 112 may represent any of a variety of suitable means for exchanging data, such as: an Internet, an intranet, an extranet, a wide area network (WAN), a local area network (LAN), a virtual private network, a satellite communications network, an Automatic Teller Machine (ATM) network, an interactive television network, or any combination of the forgoing. Network 112 may contain either or both wired and wireless connections for the transmission of signals including electrical, magnetic, and a combination thereof. Examples of such connections are known in the art and include: radio frequency connections, optical connections, etc. To illustrate, the connection for the transmission of signals may be a telephone link, a Digital Subscriber Line, or cable link. Moreover, network 112 may utilize any of a variety of communication protocols, such as Transmission Control Protocol/Internet Protocol (TCP/IP), for example. There may be multiple nodes within the network 112, each of which may conduct some level of processing on the data transmitted within the transaction processing system 100.

Users of the transaction processing system 100 may interact with one another or receive data about one another within the transaction processing system 100 using any of a variety of communication devices. The communication device may have a processing unit operatively connected to a display and memory such as Random Access Memory (“RAM”) and/or Read-Only Memory (“ROM”). The communication device may be combination of hardware and software that enables an input device such as a keyboard, a mouse, a stylus and touch screen, or the like.

For example, use of the transaction processing system 100 by the account holder 108 may include the use of a Portable Consumer payment Device (PCD). The PCD may be one of the communication devices, or may be used in conjunction with, or as part of, the communication device. The PCD may be in a form factor that can be: a card (e.g., bank card, payment card, financial card, credit card, charge card, debit card, gift card, transit pass, smart card, access card, a payroll card, security card, healthcare card, or telephone card), a tag, a wristwatch, wrist band, a key ring, a fob, a machine readable medium containing account information, a pager, a cellular telephone, a personal digital assistant, a digital audio player, a computer (e.g., laptop computer), a set-top box, a portable workstation, a minicomputer, or a combination thereof. The PCD may have near field or far field communication capabilities (e.g., satellite communication or communication to cell sites of a cellular network) for telephony or data transfer such as communication with a global positioning system (GPS). The PCD may support a number of services such as SMS for text messaging and Multimedia Messaging Service (MMS) for transfer of photographs and videos, electronic mail (email) access.

The PCD may include a computer readable medium. The computer readable medium, such as a magnetic stripe or a memory of a chip or a chipset, may include a volatile, a non-volatile, a read only, or a programmable memory that stores data, such as an account identifier, a consumer identifier, and/or an expiration date. The computer readable medium may including executable instructions that, when executed by a computer, the computer will perform a method. For example, the computer readable memory may include information such as the account number or an account holder 108's name.

Examples of the PCD with memory and executable instructions include: a smart card, a personal digital assistant, a digital audio player, a cellular telephone, a personal computer, or a combination thereof. To illustrate, the PCD may be a financial card that can be used by a consumer to conduct a contactless transaction with a merchant, where the financial card includes a microprocessor, a programmable memory, and a transponder (e.g., transmitter or receiver). The financial card can have near field communication capabilities, such as by one or more radio frequency communications such as are used in a “Blue Tooth” communication wireless protocol for exchanging data over short distances from fixed and mobile devices, thereby creating personal area networks.

Merchant 110 may utilize at least one POI terminal (e.g., Point of Service or browser enabled consumer cellular telephone); that can communicate with the account user 108, the acquirer 106, the transaction handler 102, or the issuer 104. A Point of Interaction (POI) can be a physical or virtual communication vehicle that provides the opportunity, through any channel to engage with the consumer for the purposes of providing content, messaging or other communication, related directly or indirectly to the facilitation or execution of a transaction between the merchant 110 and the consumer. Examples of the POI include: a physical or virtual Point of Service (POS) terminal, the PCD of the consumer, a portable digital assistant, a cellular telephone, paper mail, e-mail, an Internet website rendered via a browser executing on computing device, or a combination of the forgoing. Thus, the POI terminal is in operative communication with the transaction processing system 100.

The PCD may interface with the POI using a mechanism including any suitable electrical, magnetic, or optical interfacing system such as a contactless system using radio frequency, a magnetic field recognition system, or a contact system such as a magnetic stripe reader. To illustrate, the POI may have a magnetic stripe reader that makes contact with the magnetic stripe of a healthcare card (e.g., Flexible Savings Account card) of the consumer. As such, data encoded in the magnetic stripe on the healthcare card of consumer read and passed to the POI at merchant 110. These data can include an account identifier of a healthcare account. In another example, the POI may be the PCD of the consumer, such as the cellular telephone of the consumer, where the merchant 110, or an agent thereof, receives the account identifier of the consumer via a webpage of an interactive website rendered by a browser executing on a World Wide Web (Web) enabled PCD.

Typically, a transaction begins with account user 108 presenting the portable consumer device to the merchant 110 to initiate an exchange for resources (e.g., a good or service). The portable consumer device may be associated with an account (e.g., a credit account) of account holder 108 that was issued to the account holder 108 by issuer 104.

Merchant 110 may use the POI terminal to obtain account information, such as a number of the account of the account holder 108, from the portable consumer device. The portable consumer device may interface with the POI terminal using a mechanism including any suitable electrical, magnetic, or optical interfacing system such as a contactless system using radio frequency or magnetic field recognition system or contact system such as a magnetic stripe reader. The POI terminal sends a transaction authorization request to the issuer 104 of the account associated with the PCD. Alternatively, or in combination, the PCD may communicate with issuer 104, transaction handler 102, or acquirer 106.

Issuer 104 may authorize the transaction and forward same to the transaction handler 102. Transaction handler 102 may also clear the transaction. Authorization includes issuer 104, or transaction handler 102 on behalf of issuer 104, authorizing the transaction in connection with issuer 104's instructions such as through the use of business rules. The business rules could include instructions or guidelines from the transaction handler 102, the account holder 108, the merchant 110, the acquirer 106, the issuer 104, a related financial institution, or combinations thereof. The transaction handler 102 may, but need not, maintain a log or history of authorized transactions. Once approved, the merchant 110 may record the authorization, allowing the account user 108 to receive the good or service from merchant or an agent thereof.

The merchant 110 may, at discrete periods, such as the end of the day, submit a list of authorized transactions to the acquirer 106 or other transaction related data for processing through the transaction processing system 100. The transaction handler 102 may optionally compare the submitted authorized transaction list with its own log of authorized transactions. The transaction handler 102 may route authorization transaction amount requests from the corresponding acquirer 106 to the corresponding issuer 104 involved in each transaction. Once the acquirer 106 receives the payment of the authorized transaction from the issuer 104, the acquirer 106 can forward the payment to the merchant 110 less any transaction costs, such as fees for the processing of the transaction. If the transaction involves a debit or pre-paid card, the acquirer 106 may choose not to wait for the issuer 104 to forward the payment prior to paying merchant 110.

There may be intermittent steps in the foregoing process, some of which may occur simultaneously. For example, the acquirer 106 can initiate the clearing and settling process, which can result in payment to the acquirer 106 for the amount of the transaction. The acquirer 106 may request from the transaction handler 102 that the transaction be cleared and settled. Clearing includes the exchange of financial information between the issuer 104 and the acquirer 106 and settlement includes the exchange of funds. The transaction handler 102 can provide services in connection with settlement of the transaction. The settlement of a transaction includes depositing an amount of the transaction settlement from a settlement house, such as a settlement bank, which transaction handler 102 typically chooses, into a clearinghouse bank, such as a clearing bank, that acquirer 106 typically chooses. The issuer 104 deposits the same from a clearinghouse bank, such as a clearing bank, which the issuer 104 typically chooses, into the settlement house. Thus, a typical transaction involves various entities to request, authorize, and fulfill processing the transaction.

The transaction processing system 100 will preferably have network components suitable for scaling the number and data payload size of transactions that can be authorized, cleared and settled in both real time and batch processing. These include hardware, software, data elements, and storage network devices for the same. Examples of transaction processing system 100 include those operated, at least in part, by: American Express Travel Related Services Company, Inc; MasterCard International, Inc.; Discover Financial Services, Inc.; First Data Corporation; Diners Club International, LTD; Visa Inc.; and agents of the foregoing.

Each of the network/switch 102 can include one or more data centers for processing transactions, where each transaction can include up to 100 kilobytes of data or more. The data corresponding to the transaction can include information about the types and quantities of goods and services in the transaction, information about the account holder 108, the account user 108, the merchant 110, tax and incentive treatment(s) of the goods and services, coupons, rebates, rewards, loyalty, discounts, returns, exchanges, cash-back transactions, etc.

By way of example, network/switch 102 can include one or more mainframe computers (e.g., one or more IBM mainframe computers) for one or more server farms (e.g., one or more Sun UNIX Super servers), where the mainframe computers and server farms can be in diverse geographic locations. Each issuer 104 (or agent issuer 104 thereof) and each acquirer 106 (or agent acquirer 106 thereof) can use one or more router/switch (e.g., Cisco™ routers/switches) to communicate with each network/switch 102 via dedicated communication systems.

Transaction handler 102 can store information about transactions processed through transaction processing system 100 in data warehouses such as may be incorporated as part of the plurality of networks/switches 102. This information can be data mined. The data mining transaction research and modeling can be used for advertising, account holder and merchant loyalty incentives and rewards, fraud detection and prediction, and to develop tools to demonstrate savings and efficiencies made possible by use of the transaction processing system 100 over paying and being paid by cash, or other traditional payment mechanisms.

The VisaNet® system is an example component of the transaction handler 102 in the transaction processing system 100. Presently, the VisaNet® system is operated in part by Visa Inc. As of 2006, the VisaNet® system was processing around 300 million transaction daily, on over 1 billion accounts used in over 170 countries. Financial instructions numbering over 16,000 connected through the VisaNet® system to around 30 million merchants 110. In 2007, around 71 billion transactions for about 4 trillion U.S. dollars were cleared and settled through the VisaNet® system, some of which involved a communication length of around 24,000 miles in around two (2) seconds.

While one embodiment can be implemented in fully functioning computers and computer systems, various embodiments are capable of being distributed as a computing product in a variety of forms and are capable of being applied regardless of the particular type of machine or computer-readable media used to actually effect the distribution.

In embodiments, a storage medium may store instructions for practicing methods described with references to FIGS. 1-12, in accordance with various embodiments. For example, a non-transitory computer-readable storage medium may include a number of programming instructions. Programming instructions may be configured to enable a device, e.g., the device 1200, in response to execution of the programming instructions, to perform, e.g., various operations associated with an example game to be operated on a computing device based on payment transactions in an electronic payment transaction processing network, e.g., the routinely adjusted intelligent fraud rules to be configured to operate on a computing device to automatically monitor and adjust the FPR performance of fraudulent transaction rules for issuers, or other operations described herein.

Routines executed to implement the embodiments may be implemented as part of an operating system or a specific application, component, program, object, module or sequence of instructions referred to as “computer programs.” The computer programs typically include one or more instructions set at various times in various memory and storage devices in a computer, and that, when read and executed by one or more processors in a computer, cause the computer to perform operations necessary to execute elements involving the various aspects.

The non-transitory computer-readable storage medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, ROM, RAM, flash memory devices, floppy and other removable disks, magnetic disk storage media, optical storage media (e.g., Compact Disk Read-Only Memory (CD ROMS), Digital Versatile Disks (DVDs), etc.), among others. The computer-readable media may store the instructions.

The instructions may also be embodied in digital and analog communication links for electrical, optical, acoustical or other forms of propagated signals, such as carrier waves, infrared signals, digital signals, etc. However, propagated signals, such as carrier waves, infrared signals, digital signals, etc. are not tangible machine readable medium and are not configured to store instructions.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

The description and drawings are illustrative and are not to be construed as limiting. The present disclosure is illustrative of disclosed features to enable a person skilled in the art to make and use the techniques. Various features, as described herein, should be used in compliance with all current and future rules, laws and regulations related to privacy, security, permission, consent, authorization, and others. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

What is claimed is:

1. A computer-implemented method, comprising:
receiving, by a processor, a request to evaluate a transaction based on a first false positive ratio (FPR), wherein the first FPR is associated with a FPR threshold generated by a user;
retrieving, by the processor, a first list of fraudulent transaction rules, wherein the first list of fraudulent transaction rules include a plurality of fraud rules associated with a plurality of FPRs;
removing, by the processor, one or more fraudulent transaction rules from the first list of fraudulent transaction rules to create one or more first fraudulent transaction rules that are aligned with the first FPR of the FPR threshold of the user;
determining, by the processor, whether a set of parameters associated with the one or more first fraudulent transaction rules are met based on the first FPR of the FPR threshold of the user;
transmitting, by the processor, a decline response to the request to evaluate the transaction based on the determination that the one or more first fraudulent transaction rules are met; and
generating, by the processor, a second list of fraudulent transaction rules based on the first list of fraudulent transaction rules, wherein the second list of fraudulent transaction rules is dynamically adjusted based on feedback data associated with the one or more first fraudulent transaction rules and the first list of fraudulent transaction rules.

2. The method of claim 1, wherein the FPR threshold of the user is associated with a plurality of rule performance data points.

3. The method of claim 2, wherein the plurality of rule performance data points includes a rule name, a plurality of rule inputs, a number of cases associated with rules confirmed fraud over a period of time, and a number of cases associated with rules confirmed not fraud over the period of time.

4. The method of claim 3, wherein the plurality of FPRs are generated from a plurality of first cases associated with confirmed fraudulent transactions over the period of time, and a plurality of second cases associated with confirmed non-fraudulent transactions over the period of time.

5. The method of claim 1, wherein the feedback data is comprised of a plurality of verification responses, and wherein the plurality of verification responses determine whether the transaction was a confirmed non-fraudulent transaction or a confirmed fraudulent transaction, and wherein the plurality of verification responses include an automated email response, an automated text message response, or an automated voice response.

6. The method of claim 1, further comprising:
transmitting, by the processor, an approve response to the request to evaluate the transaction based on the determination that the one or more first fraudulent transaction rules are not met;
generating, by the processor, a case to evaluate the decline response based on the feedback data; and
receiving, by a processor, a second request to evaluate a second transaction based on the first FPR and the second list of fraudulent transaction rules, wherein the second list of fraudulent transaction rules include a plurality of second fraud rules associated with a plurality of second FPRs, and wherein at least one of the feedback data and the case dynamically adjusts the plurality of fraud rules and the plurality of FPRs of the first list of fraudulent transaction rules to generate the plurality of second fraud rules and the plurality of second FPRs of the second list of fraudulent transaction rules.

7. The method of claim 1, wherein the FPR includes a 1:1 FPR, a 2:1 FPR, a 3:1 FPR, or a 4:1 FPR, wherein the 1:1 FPR indicates for one fraudulent transaction declined, one legitimate transaction suspected as fraudulent is erroneously declined, wherein the 2:1 FPR indicates for one fraudulent transaction declined, two legitimate transactions suspected as fraudulent are erroneously declined, wherein the 3:1 FPR indicates for one fraudulent transaction declined, three legitimate transactions suspected as fraudulent are erroneously declined, and wherein the 4:1 FPR indicates for one fraudulent transaction declined, four legitimate transactions suspected as fraudulent are erroneously declined.

8. A system, comprising:
a transaction database storing payment transaction records;
a processor having access to the transaction database; and
a software component executed by the processor that is configured to:
receive a request to evaluate a transaction based on a first false positive ratio (FPR), wherein the first FPR is associated with a FPR threshold generated by a user;
retrieve a first list of fraudulent transaction rules, wherein the first list of fraudulent transaction rules include a plurality of fraud rules associated with a plurality of FPRs;
remove one or more fraudulent transaction rules from the first list of fraudulent transaction rules to create one or more first fraudulent transaction rules that are aligned with the first FPR of the FPR threshold of the user;
determine whether a set of parameters associated with the one or more first fraudulent transaction rules are met based on the first FPR of the FPR threshold of the user;
transmitting a decline response to the request to evaluate the transaction based on the determination that the one or more first fraudulent transaction rules are met; and
generating a second list of fraudulent transaction rules based on the first list of fraudulent transaction rules, wherein the second list of fraudulent transaction rules is dynamically adjusted based on feedback data associated with the one or more first fraudulent transaction rules and the first list of fraudulent transaction rules.

9. The system of claim 8, wherein the FPR threshold of the user is associated with a plurality of rule performance data points.

10. The system of claim 9, wherein the plurality of rule performance data points includes a rule name, a plurality of rule inputs, a number of cases associated with rules confirmed fraud over a period of time, and a number of cases associated with rules confirmed not fraud over the period of time.

11. The system of claim 10, wherein the plurality of FPRs are generated from a plurality of first cases associated with confirmed fraudulent transactions over the period of time, and a plurality of second cases associated with confirmed non-fraudulent transactions over the period of time.

12. The system of claim 10, wherein the feedback data is comprised of a plurality of verification responses, and wherein the plurality of verification responses determine whether the transaction was a confirmed non-fraudulent transaction or a confirmed fraudulent transaction, and wherein the plurality of verification responses include an automated email response, an automated text message response, or an automated voice response.

13. The system of claim 8, further comprising:
transmit an approve response to the request to evaluate the transaction based on the determination that the one or more first fraudulent transaction rules are not met;
generate a case to evaluate the decline response based on the feedback data; and
receive a second request to evaluate a second transaction based on the first FPR and the second list of fraudulent transaction rules, wherein the second list of fraudulent transaction rules include a plurality of second fraud rules associated with a plurality of second FPRs, and wherein at least one of the feedback data and the case dynamically adjusts the plurality of fraud rules and the plurality of FPRs of the first list of fraudulent transaction rules to generate the plurality of second fraud rules and the plurality of second FPRs of the second list of fraudulent transaction rules.

14. The system of claim 8, wherein the FPR includes a 1:1 FPR, a 2:1 FPR, a 3:1 FPR, or a 4:1 FPR, wherein the 1:1 FPR indicates for one fraudulent transaction declined, one legitimate transaction suspected as fraudulent is erroneously declined, wherein the 2:1 FPR indicates for one fraudulent transaction declined, two legitimate transactions suspected as fraudulent are erroneously declined, wherein the 3:1 FPR indicates for one fraudulent transaction declined, three legitimate transactions suspected as fraudulent are erroneously declined, and wherein the 4:1 FPR indicates for one fraudulent transaction declined, four legitimate transactions suspected as fraudulent are erroneously declined.

15. A computer-readable medium containing program instructions for:
receiving, by a processor, a request to evaluate a transaction based on a first false positive ratio (FPR), wherein the first FPR is associated with a FPR threshold generated by a user;
retrieving, by the processor, a first list of fraudulent transaction rules, wherein the first list of fraudulent transaction rules include a plurality of fraud rules associated with a plurality of FPRs;
removing, by the processor, one or more fraudulent transaction rules from the first list of fraudulent transaction rules to create one or more first fraudulent transaction rules that are aligned with the first FPR of the FPR threshold of the user;
determining, by the processor, whether a set of parameters associated with the one or more first fraudulent transaction rules are met based on the first FPR of the FPR threshold of the user;
transmitting, by the processor, a decline response to the request to evaluate the transaction based on the determination that the one or more first fraudulent transaction rules are met; and
generating, by the processor, a second list of fraudulent transaction rules based on the first list of fraudulent transaction rules, wherein the second list of fraudulent transaction rules is dynamically adjusted based on feedback data associated with the one or more first fraudulent transaction rules and the first list of fraudulent transaction rules.

16. The computer-readable medium of claim 15, wherein the FPR threshold of the user is associated with a plurality of rule performance data points, and wherein the plurality of rule performance data points includes a rule name, a plurality of rule inputs, a number of cases associated with rules confirmed fraud over a period of time, and a number of cases associated with rules confirmed not fraud over the period of time.

17. The computer-readable medium of claim 17, wherein the plurality of FPRs are generated from a plurality of first cases associated with confirmed fraudulent transactions over the period of time, and a plurality of second cases associated with confirmed non-fraudulent transactions over the period of time.

18. The computer-readable medium of claim 15, wherein the feedback data is comprised of a plurality of verification responses, wherein the plurality of verification responses determine whether the transaction was a confirmed non-fraudulent transaction or a confirmed fraudulent transaction, and wherein the plurality of verification responses include an automated email response, an automated text message response, or an automated voice response.

19. The computer-readable medium of claim 15, further comprising:
transmitting, by the processor, an approve response to the request to evaluate the transaction based on the determination that the one or more first fraudulent transaction rules are not met;
generating, by the processor, a case to evaluate the decline response based on the feedback data; and
receiving, by a processor, a second request to evaluate a second transaction based on the first FPR and the second list of fraudulent transaction rules, wherein the second list of fraudulent transaction rules include a plurality of second fraud rules associated with a plurality of second FPRs, and wherein at least one of the feedback data and the case dynamically adjusts the plurality of fraud rules and the plurality of FPRs of the first list of fraudulent transaction rules to generate the plurality of second fraud rules and the plurality of second FPRs of the second list of fraudulent transaction rules.

20. The computer-readable medium of claim 18, wherein the FPR includes a 1:1 FPR, a 2:1 FPR, a 3:1 FPR, or a 4:1 FPR, wherein the 1:1 FPR indicates for one fraudulent transaction declined, one legitimate transaction suspected as fraudulent is erroneously declined, wherein the 2:1 FPR indicates for one fraudulent transaction declined, two legitimate transactions suspected as fraudulent are erroneously declined, wherein the 3:1 FPR indicates for one fraudulent transaction declined, three legitimate transactions suspected as fraudulent are erroneously declined, and wherein the 4:1 FPR indicates for one fraudulent transaction declined, four legitimate transactions suspected as fraudulent are erroneously declined.
